(19) United States
(12) Patent Application Publication
(10) Pub. No.: US 2009/0073131 A1
(43) Pub. Date: Mar. 19, 2009

(54) METHOD FOR DETERMINING MULTIPLE TOUCH INPUTS ON A RESISTIVE TOUCH SCREEN AND A MULTIPLE TOUCH CONTROLLER

(75) Inventor: Feng-Chih Yeh, Kaohsiung City (TW)

Correspondence Address: WPAT, PC, 7225 BEVERLY ST., ANNANDALE, VA, 22003, US

(73) Assignee: J TOUCH CORPORATION, Taoyuan Hsien (TW)

(21) Appl. No.: 11/858,070

(22) Filed: Sep. 19, 2007

(51) Int. Cl. G06F 3/041

(52) U.S. Cl. 345/173

(57) ABSTRACT

The present invention provides a method for determining multiple touch inputs on a resistive touch screen, the method comprises determining a touching sequence between a first object and a second object when the first object and the second object touch the resistive touch screen respectively; calculating coordinate of a first point and coordinate of a midpoint according to voltage drop in the resistive touch screen meanwhile the first object keeps touching the resistive touch screen; and calculating coordinate of a second point according to coordinate of the first point and coordinate of the midpoint.

### BACKGROUND OF THE INVENTION

1. Field of the Invention

This invention generally relates to a touch system and touch digitizer. The invention more particularly relates to a multiple touch controller and a method for determining multiple touch inputs on a resistive touch screen.

2. Description of the Related Art

In 1970, touch screen is originated for military usage in United States of America. Until 1980, technologies related to touch screen were published and utilized to be other applications. Now, touch screen is universal and applied to replace input devices like keyboard or mouse. Especially, most of electrical equipments such as Automatic Teller Machine (ATM), Kiosks, Point of Service (POS), household appliances, industrial electronics and etc are equipped with touch screen and its technologies to make input easily. In addition, more and more the consumer products take this trend to make them thin, light, short and small to carry, for example, personal digital assistant (PDA), mobile phone, notebook, laptop, MP3 player and so on.

Resistive touch screen is a mainstream in the market because of low cost. Resistive touch screens have a flexible top layer and a rigid bottom layer separated by insulating dots, with the inside surface of each layer coated with a transparent metal oxide. Pressing the flexible top sheet creates electrical contact between the resistive layers, essentially closing a switch in the circuit. The control electronics alternate voltage between the layers to get x then y touch coordinates. However, resistive touch screen has a great disadvantage when it is used to perform multiple touch function. For example, when a user touches the screen on point A and B by two fingers, the flexible top layer may contacts the rigid bottom layer in a line constructed between point A and B, and it causes the middle point is sensed/determined on the line rather than correct points A and B that the user wants to make.

It is understood that the disadvantage of the resistive touch screen is required to improve when the products need multiple touch function. Therefore, the present invention provides a method for determining multiple touch inputs on a resistive touch screen and also provides a multiple touch controller which is applied to a resistive touch screen.

### BRIEF SUMMARY OF THE INVENTION

To solve the disadvantage of the prior art. The present invention provides a method for determining multiple touch inputs on a resistive touch screen and also provides a multiple touch controller which is applied to a resistive touch screen.

The one embodiment of the present invention is to calculate coordinate of a second points on the resistive touch screen according to coordinate of an antecedent point and coordinate of a midpoint, while the antecedent point is the first point touched/determined on the resistive touch screen, and the midpoint is between the antecedent point and the second point.

The other embodiment of the present invention is to calculate coordinate of second points on the resistive touch screen according to coordinate of an antecedent point, coordinate of a midpoint and a vector, while the vector is also calculated based on coordinate of the antecedent point and coordinate of the midpoint.

To achieve these aspects mentioned above, the present invention provides a method for determining multiple touch inputs on a resistive touch screen, the method comprises determining a touching sequence between a first object and a second object when the first object and the second object touch the resistive touch screen respectively, calculating coordinate of a first point and coordinate of a midpoint according to voltage drop in the resistive touch screen meanwhile the first object keeps touching the resistive touch screen, and calculating coordinate of a second point according to coordinate of the first point and coordinate of the midpoint.

The present invention also provides a multiple touch controller which is applied to a resistive touch screen, the multiple touch controller comprises at least one first-in-first-out buffer for storing a set of coordinate having X-axis and Y-axis on the resistive touch screen, a touch detecting circuit for accessing the first-in-first-out buffer, determining whether lager than a threshold, determining whether having any else touch points and outputting a control signal, a touch mode switching circuit for receiving the control signal from the touch detecting circuit to determine status of the touch mode switching circuit, a coordinate generating circuit for accessing the first-in-first-out buffer, the coordinate selecting circuit, and status of the touch mode switching circuit to obtain value of X-axis and Y-axis, a coordinate register for storing value of X-axis and Y-axis transmitted from the coordinate generating circuit, a coordinate selecting circuit for referring the coordinate register and the first-in-first-out buffer at the same time, and calculating coordinate value of the second point, a midpoint generating circuit for calculating multiple midpoints between multiple touches on the touch screen, and a coordinate comparing circuit for determining whether any touches is released or not and transmitting a signal to the touch mode switching circuit.

The present invention provides a method and a multiple touch controller to determine multiple touches on the resistive screen with several advantages such as simple architecture, elementary theorem, low cost, re-design off and so on.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A-1C are schematic diagrams of calculation of coordinate based on an antecedent point according to one embodiment of the present invention;

FIG. 2A-2E are schematic diagrams of calculation of coordinate based on an antecedent point according to another embodiment of the present invention;

FIG. 3 is a flowchart for illustrating determination of multiple touch inputs on a resistive touch screen according to one embodiment of the present invention;

FIG. 4 is a functional diagram of a multiple touch controller for a restrictive touch screen according to one embodiment of the present invention; and

FIG. 5A-5C are functional diagrams of a multiple touch controller for illustrating signals transmission between several functional blocks according to one embodiment of the present invention;

### DETAILED DESCRIPTION OF THE INVENTION

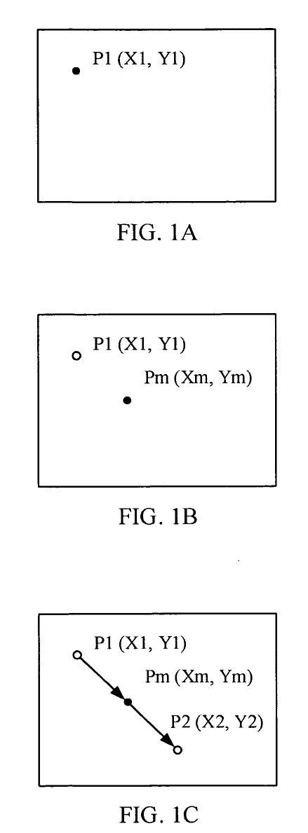

Several exemplary embodiments of the invention are described with reference to FIGS. 1A through 5C, which generally relate to a method for determining multiple touch inputs on a resistive touch screen. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

Referring to FIG. 1A-1C, they are schematic diagrams of calculation of coordinate based on an antecedent point according to one embodiment of the present invention. In FIG. 1A, an antecedent point P1 is determined when a finger keeps touching on the restrictive screen. In FIG. 1B, a midpoint Pm is determined by detecting discrete voltage drop between the antecedent point P1 and a second point P2 shown in FIG. 1C. The second point is pressed by another finger after the antecedent point P1. As mentioned above, the system receives two coordinate of points P1 (X1, Y1) and Pm (Xm, Ym) and calculates coordinate of the second point P2 (X2, Y2) through a vector. The vector is also calculated by the P1 (X1, Y1) and Pm (Xm, Ym).

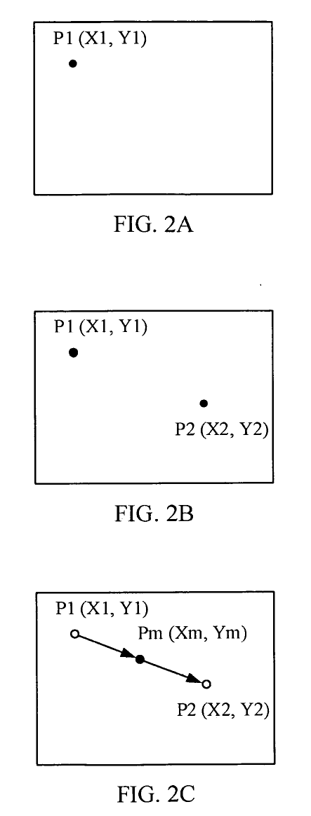

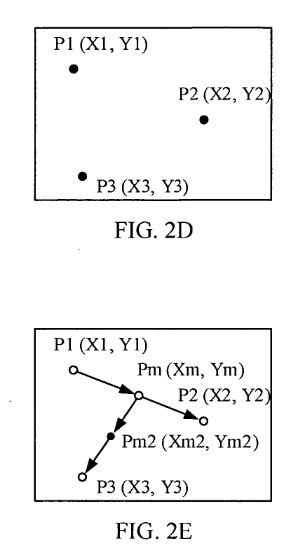

Referring to FIG. 2A-2E, they are schematic diagrams of calculation of coordinate based on an antecedent point according to another embodiment of the present invention. Here illustrates three touch inputs on the restrictive touch screen. First, providing a restrictive touch screen, determining a touching sequence between P1, P2, and P3 (for example, the sequence is P1 before P2 before P3), receiving coordinate of P1 and Pm1 as the theorem described as above, calculating coordinate of P2 based on coordinate of P1 and Pm1, receiving coordinate of Pm2, and calculating coordinate of P3 based on coordinate of Pm1 and Pm2.

Through description as above, the theorem is that determining an antecedent point when only a first object (ex. thumb) touches the screen and determining a midpoint by discrete voltage drop when another finger (ex. forefinger) touches the screen after thumb. Then sequentially receiving the last midpoint to calculate the next point. In other words, assume there are (n−1) points being pressed on the screen at the same time, there is the midpoint Pmₙ₋₂ Now comes n-th point Pn pressed, Pmₙ₋₁ will be the midpoint between Pn and Pmₙ₋₂. Owning to it detects the point Pmₙ₋₁ and Pm sequentially on the resistive touch screen, the point Pn could be calculated based on Pmₙ₋₁ and Pm. Generally speaking, determining a touching sequence between N points (ex. P1, P2, P3, . . . , Pn), detecting coordinate of P1, Pm1, Pm2, Pm3, . . . , Pmₙ₋₁, and calculating coordinate of P2, P3, . . . , Pn according to Pm1, Pm2, Pm3, Pmₙ₋₁.

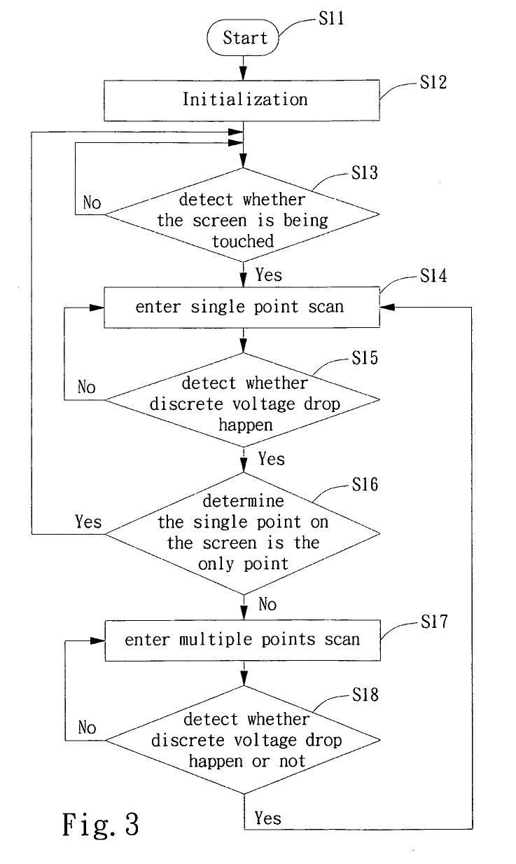

Referring to FIG. 3, it is a flowchart for illustrating determination of multiple touch inputs on a resistive touch screen according to one embodiment of the present invention.

Step S11: start this flow.

Step S12: initialize each functional block, internal circuit for initialization of coordinate.

Step S13: detect whether the screen is being touched or not, if yes, go to Step 14, if no, go to Step 13.

Step S14: enter single point scan to receive coordinate of the first point (the antecedent point).

Step S15: detect whether discrete voltage drop happen or not, it means the second object keeps touching the screen at the same time; if yes, go to Step 16, or go to Step 14.

Step S16: determine the single point on the screen is the only point or not, if yes, go to Step 13, if no, go to Step 17.

Step S17: enter multiple points scan, calculate each of touching points according to the antecedent point, each of midpoints and the vectors.

Step S18: detect whether discrete voltage drop happen or not, it means the third object keeps touching the screen at the same time; if yes, go to Step 14, if no, go to Step 17.

In addition, the equations to calculate the next point based on a known point on the X-axis as follows:

$$First point \text{:} {X}_{1} = NEWx ;$$

$$Second point \text{:} {X}_{2} = [ ( {NEW}_{X} - {mid}_{x 1} ) \times 2 ] + {mid}_{x 1} , wherein {mid}_{x 1} = {X}_{1} ;$$

$$Third point \text{:} {X}_{3} = [ ( {NEW}_{X} - {mid}_{x 2} ) \times 2 ] + {mid}_{x 2} , wherein {mid}_{x 2} = \frac{{X}_{2} - {mid}_{x 1}}{2} + {mid}_{x 1} ;$$

$$Fourth point \text{:} {X}_{4} = [ ( {NEW}_{X} - {mid}_{x 3} ) \times 2 ] + {mid}_{x 3} = \frac{{X}_{3} - {mid}_{x 2}}{2} + {mid}_{x 2} ;$$

$$Fifth point \text{:} {X}_{5} = [ ( {NEW}_{X} - {mid}_{x 4} ) \times 2 ] + {mid}_{x 4} , wherein {mid}_{x 4} = \frac{{X}_{4} - {mid}_{x 3}}{2} + {mid}_{x 3} ;$$

$$Conclusion \text{:}$$

$${X}_{1} = {NEW}_{X} , {mid}_{x 1} = {X}_{1}$$

$${X}_{n} = ⌊ ( {NEW}_{X} - {mid}_{x ( n - 1 )} ) \times 2 ⌋ + {mid}_{x ( n - 1 )}$$

$$wherein {mid}_{x ( n )} = \frac{{X}_{n} - {mid}_{x ( n - 1 )}}{2} + {mid}_{x ( n - 1 )}$$

Y-axis is the same as X-axis:

$${Y}_{1} = NEWy , {mid}_{y 1} = {Y}_{1}$$

$${Y}_{n} = ⌊ ( {NEW}_{y} - {mid}_{y ( n - 1 )} ) \times 2 ⌋ + {mid}_{y ( n - 1 )}$$

$$wherein {mid}_{y ( n )} = \frac{{X}_{y} - {mid}_{y ( n - 1 )}}{2} + {mid}_{y ( n - 1 )}$$

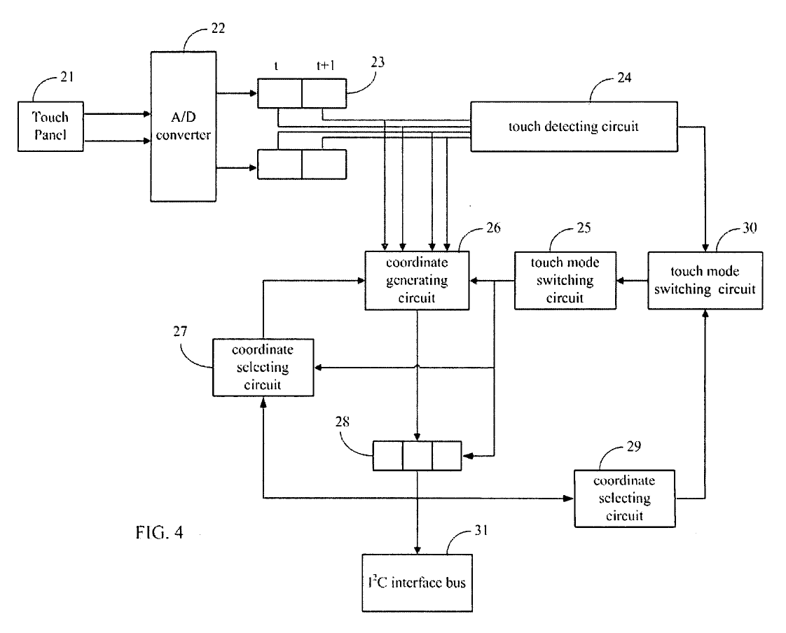

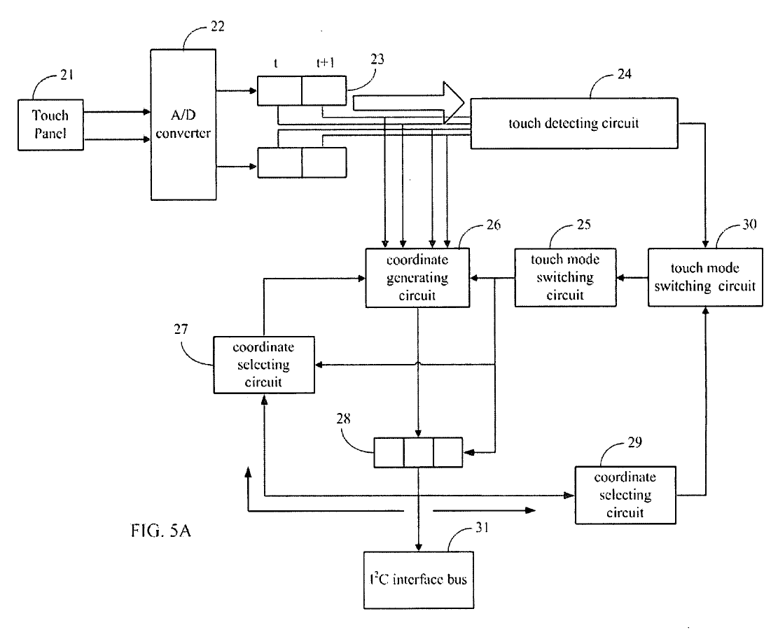

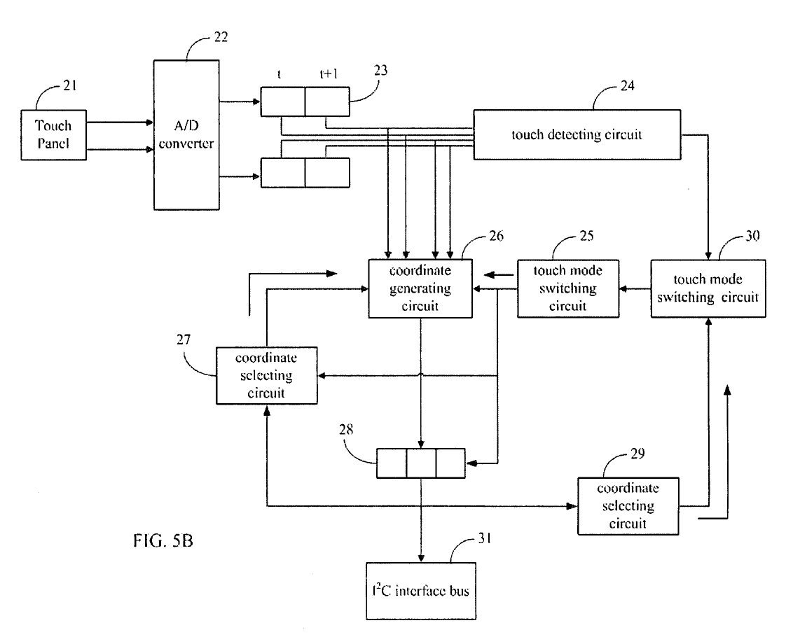

Referring to FIG. 4, it is a functional diagram of a multiple touch controller for a restrictive touch screen according to one embodiment of the present invention.

The system includes a resistive touch panel 21 coupled to an analog to digital converter 22 coupled to a first-in-first-out buffer 23, a touch detecting circuit 24, a touch mode switching circuit 25 coupled to a coordinate generating circuit 26, a coordinate selecting circuit 27, a coordinate register 28, a midpoint calculating circuit 29, a coordinate comparing circuit 30 coupled to the touch mode switching circuit 25, and an I²C interface bus 31 coupled to the coordinate register 28.

The resistive touch panel 21 transmit analog signals to the analog to digital converter 22 for translating analog signals to digital signals, the A/D converter 22 transmits coordinate of X-axis and Y-axis into the first-in-first-out buffer 23. The first-in-first-out buffer 23 includes two columns to store two set of coordinate of points on time t and t+1. When the difference of coordinate of points t and t+1 is larger than a predetermined value, it means there are two objects touch on the screen and the touch detecting circuit 24 will transmit a status signal to the touch mode switching circuit 25 for identification of the status change. Meanwhile, the coordinate generating circuit 26 calculates coordinate of the new point according to status of the touch mode switching circuit 25, coordinate of the first-in-first-out buffer 23 and coordinate of the coordinate register 28 accessed by the coordinate selecting circuit 27. The value of X-axis and Y-axis stored in the coordinate register 28 is outputted by the I²C interface bus 31. The midpoint calculating circuit 29 is for calculating each of midpoints and transmits information to the coordinate comparing circuit 30 for determining which points is released. The coordinate register 28 could be a right shift register or left shift register for storing coordinate of points. In this embodiment, the coordinate register 28 can store three sets of coordinate, but not limited to.

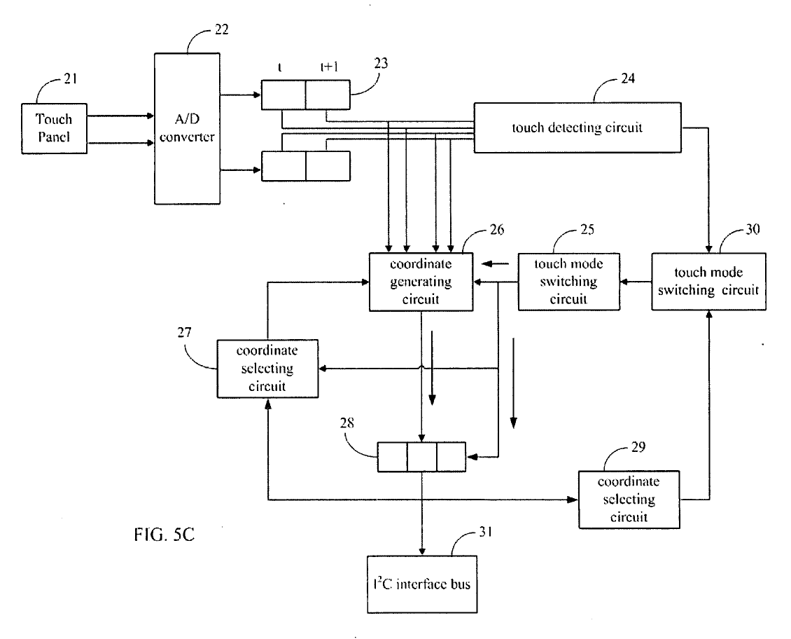

Referring to FIG. 5A-5C, they are functional diagrams of a multiple touch controller for illustrating signals transmission between several functional blocks according to one embodiment of the present invention.

In FIG. 5A, the value of coordinate is transmitted from the first-in-first-out buffer 23 to the touch detecting circuit 24 and to the coordinate generating circuit 26 for calculation. At the same time, the value of coordinate is transmitted from the coordinate register 28 to the midpoint calculating circuit 29 for calculating coordinate of the current point to the coordinate selecting circuit 27.

In FIG. 5B, the coordinate comparing circuit 30 determines whether any point is released according to information provided by the midpoint calculating circuit 29, and provides information to the touch mode switching circuit 25 for changing status. The coordinate selecting circuit 27 selects proper coordinate according to signals from the touch mode switching circuit 25, to the coordinate generating circuit 26.

In FIG. 5C, the coordinate generating circuit 26 generates correct coordinate of new point according to information from the first-in-first-out buffer 23 and the coordinate selecting circuit 27. The touch mode switching circuit 25 selects proper output to the coordinate register 28 for refresh new coordinate. Then the new coordinate is outputted by the I²C interface bus 31 or an SPI interface (not shown).

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for determining multiple touch inputs on a resistive touch screen, the method comprises:
determining a touching sequence between a first object and at least one second object when the first object and the second object touch the resistive touch screen respectively;
calculating coordinate of a first point and coordinate of a midpoint according to voltage drop in the resistive touch screen meanwhile the first object keeps touching the resistive touch screen; and
calculating coordinate of a second point according to coordinate of the first point and coordinate of the midpoint.

2. The method as claimed in claim 1, wherein determining the touching sequence is performed by a first-in-first-out (FIFO) buffer.

3. The method as claimed in claim 2, further comprising:
transmitting coordinate of the first point and coordinate of the midpoint to a touch detecting circuit and a coordinate generating circuit; and
storing coordinate of the first point and coordinate of the midpoint in a coordinate register.

4. The method as claimed in claim 3, further comprising:
transmitting coordinate of the first point and coordinate of the midpoint from the coordinate register to a midpoint generating circuit and a coordinate selecting circuit.

5. The method as claimed in claim 4, further comprising:
determining whether having any else touch inputs by a coordinate comparing circuit according to the result of the midpoint generating circuit;
transmitting a status signal by a touching mode selecting circuit; and
transmitting a proper coordinate value to the coordinate generating circuit according to the status signal.

6. The method as claimed in claim 5, wherein the coordinate generating circuit calculates coordinate of the second point according to results from the first-in-first-out buffer and the coordinate selecting circuit, the touch mode switching circuit transmits coordinate of the second point to the coordinate register, outputs coordinate of the second point by an interface bus.

7. The method as claimed in claim 6, wherein the interface bus is a I²C interface or a serial peripheral interface (SPI).

8. The method as claimed in claim 2, wherein the first-in-first-out buffer is capable of storing two sets of coordinate having X-axis and Y-axis.

9. The method as claimed in claim 2, wherein the first-in-first-out buffer is capable of storing more than two sets of coordinate having X-axis and Y-axis.

10. The method as claimed in claim 3, wherein the touch detecting circuit is utilized to access the value in the first-in-first-out buffer, determine whether lager than a threshold, determine whether having any else touch points and outputs a control signal.

11. The method as claimed in claim 10, wherein the touch mode switching circuit is utilized to receive the control signal from the touch detecting circuit for determining status of the touch mode switching circuit.

12. The method as claimed in claim 4, wherein the coordinate generating circuit is utilized to access the first-in-first-out buffer, the coordinate selecting circuit, and status of the touch mode switching circuit to obtain value of X-axis and Y-axis.

13. The method as claimed in claim 3, wherein the coordinate register is capable of storing the value of X-axis and Y-axis transmitted from the coordinate generating circuit.

14. The method as claimed in claim 3, wherein the coordinate selecting circuit is capable of referring the coordinate register and the first-in-first-out buffer at the same time, and calculating coordinate value of the second point.

15. The method as claimed in claim 4, wherein the midpoint generating circuit is capable of calculating multiple midpoints between multiple touches on the touch screen.

16. The method as claim in claim 5, wherein the coordinate comparing circuit is utilized to compare which touches is released and transmit a signal to the touch mode switching circuit.

17. A multiple touch controller which is applied to a resistive touch screen, the multiple touch controller comprises:
at least one first-in-first-out buffer for storing a set of coordinate having X-axis and Y-axis on the resistive touch screen;
a touch detecting circuit for accessing the first-in-first-out buffer, determining whether lager than a threshold, determining whether having more than two touch points and outputting a control signal;
a touch mode switching circuit for receiving the control signal from the touch detecting circuit to determine status of the touch mode switching circuit;
a coordinate generating circuit for accessing the first-in-first-out buffer, the coordinate selecting circuit, and status of the touch mode switching circuit to obtain value of X-axis and Y-axis;
a coordinate register for storing value of X-axis and Y-axis transmitted from the coordinate generating circuit;
a coordinate selecting circuit for referring the coordinate register and the first-in-first-out buffer at the same time, and calculating coordinate value of the second point;
a midpoint generating circuit for calculating multiple midpoints between multiple touches on the touch screen; and
a coordinate comparing circuit for determining whether any touches is released or not and transmitting a signal to the touch mode switching circuit.

18. The multiple touch controller as claimed in claim 17, wherein the value of coordinate having X-axis and Y-axis is outputted by an interface bus.

19. The multiple touch controller as claimed in claim 18, wherein the interface bus is a I²C interface or a serial peripheral interface (SPI).

20. The multiple touch controller as claimed in claim 17, wherein the coordinate register could be a left-shift register or a right-shift register.
